(19) United States
(12) Patent Application Publication
(10) Pub. No.: US 2014/0297565 A1
(43) Pub. Date: Oct. 2, 2014

(54) SYSTEMS AND METHODS FOR PROVIDING SHARE ASSESSMENT DATA WITH PLAIN LANGUAGE INTERPRETATION

(71) Applicant: SKAFFOLD PTY LIMITED, Pyrmont (AU)

(72) Inventor: Roger James Montgomery, Pyrmont (AU)

(73) Assignee: SKAFFOLD PTY LIMITED, Pyrmont (AU)

(21) Appl. No.: 14/348,821

(22) PCT Filed: Sep. 28, 2012
(86) PCT No.: PCT/AU2012/001178

§ 371 Date: Mar. 31, 2014

(30) Foreign Application Priority Data
Sep. 29, 2011 (AU) 2011226957

(51) Int. Cl. G06Q 40/06

(52) U.S. Cl. CPC G06Q 40/06
USPC 705/36 R

(57) ABSTRACT

A computer-implemented method for transforming share assessment data into plain language, the method including:

maintaining access to a repository of data for a plurality of shares;

receiving, from a client, a share assessment request, the share assessment request being indicative of a user-selected share and a user-selected assessment type;

identifying a set of data fields associated with the user-selected assessment type;

obtaining from the repository, for the user-selected share, values for the identified data fields;

executing a plain language conversion algorithm defined for the user-selected assessment type in respect of the obtained values thereby to generate a string of plain language prose;

providing the string of plain language prose for display to the client.

### FIELD OF THE INVENTION

The present invention relates to analysis of share assessment data, and more particularly to systems and methods for transforming share assessment data into plain language. Some embodiments of the invention have been particularly developed to assist users to analyse and understand information relating to stocks, equities or shares and the underlying businesses, so as to make better informed choices in the acquisition and/or disposal of shares from the perspective of “value investing”. It should be appreciated, however, that the invention is not limited to this particular field of use, and is also applicable in other contexts.

BACKGROUND

The following discussion of the prior art is intended to place the invention in an appropriate technical context and allow the potential advantages of it to be more fully understood. It should be appreciated, however, that any reference in this specification to prior art does not constitute an express or implied admission that such art is widely known or is common general knowledge in the relevant field.

In the field of business investment, various techniques and tools have been developed to assist in understanding the financial performance of businesses that are prospective targets for investment, and also to assist in predicting the future performance of those businesses, and ultimately their shares, equities or stocks. The majority of such techniques and tools are focused on predicting how the share price of a business on a particular stock market will move at some point in the future and therefore rely heavily on factors that are believed to influence the behaviour of the relevant stock, or stock market.

One popular technique is typically referred to as technical analysis or “charting”, whereby professional analysts or traders will evaluate how and when to trade into and out of particular shares or financial markets based on price movements within these markets. This is usually done using pattern-based concepts as “trendlines”, “trend channels”, “support and resistance” levels, “head and shoulder” formations and the like. These are typically reflected graphically in dedicated charts, and interpreted subjectively in combination with related technical indicators such as “historical price volatility”, “moving average convergence/divergence”, “directional movement” indices and the like.

A significant limitation with this approach is that it is based primarily on market-based measures such as share prices or price to earnings (P/E) ratios which are, at least to some extent, extrinsic to the underlying businesses and which are strongly influenced by prevailing market sentiment and perceptions. This in turn results in share price movements that are regularly decoupled from the performance of the underlying businesses in terms direction, magnitude and volatility.

The philosophy and technique of “value investing”, by contrast, places primary emphasis on the evaluation of intrinsic factors that are inherent in the businesses themselves such as earnings per share, return on equity, profitability, debt to equity, and the like. These factors can be analysed independently of the prevailing perceptions and sentiments of the stock market and short-term fluctuations in market pricing. The value investment philosophy is, however, predicated on the expectation that in the long term, the market price for stocks or shares in a business will eventually converge toward or oscillate around the “intrinsic value” of that business.

Hence, the primary objective behind the value investing technique is to establish an estimate of intrinsic value of a business, which may change over time as the business develops, and to acquire shares in the business at a market price that is substantially below that intrinsic value, on the expectation that in the medium to long term, price and intrinsic value will tend to converge. A refinement in the technique is to independently assess the intrinsic quality of businesses and to restrict investments to businesses that are not only trading at a discount to their intrinsic value, but are also of a high quality. This aspect is important because from a value investment perspective, there may be little point in buying shares that are relatively inexpensive if the poor quality of the underlying business does not ultimately justify a higher valuation. Conversely, the quality of superior businesses tends eventually to be reflected in the share price. Assessment of the intrinsic quality of a business can be based on a range of considerations and inputs, including for example inputs related to financial risk and performance.

There have hitherto been numerous software and other tools available to assist analysts, investors and fund managers involved in technical analysis, charting and other popular investment techniques of this type. However, because they are based on a fundamentally different investment philosophy or style (essentially analysing shares rather than businesses) with primary emphasis on extrinsic inputs, they are not readily adapted for use in the context of value investing.

It is an object of the present invention, at least in some embodiments, to overcome or substantially ameliorate one or more of the deficiencies of the prior art, or at least to provide a useful alternative.

### SUMMARY OF THE INVENTION

In a first aspect, the invention provides a computer-implemented method for transforming share assessment data into plain language, the method including:

maintaining access to a repository of data for a plurality of shares;

receiving, from a client, a share assessment request, the share assessment request being indicative of a user-selected share and a user-selected assessment type;

identifying a set of data fields associated with the user-selected assessment type;

obtaining from the repository, for the user-selected share, values for the identified data fields;

executing a plain language conversion algorithm defined for the user-selected assessment type in respect of the obtained values thereby to generate a string of plain language prose; and providing the string of plain language prose for display to the client.

In one embodiment, the process of executing the plain language conversion algorithm includes the steps of:

(i) analysing a first data field value;

(ii) based on analysis of the first data field value, selecting a first prose string portion from a group of potential first prose string portions;

(iii) repeating (i) and (ii) for a second data field value to an n^{th} data field value thereby to select a second prose string portion to an n^{th} prose string portion, where n>2; and (iv) combining the first to the n^{th} prose string portions thereby to define the string of plain language prose.

In some embodiments, for at least one value of i, wherein 1<i<n, the i^{th} prose string is selected based on analysis of the i^{th} data field value and at least a further one of the data field values.

In some embodiments, for at least one value of i, wherein 1<i<n, the i^{th} prose string is selected based on analysis of the i^{th} data field value and a k^{th} prose string, wherein 1<k<i.

In some embodiments, there are greater than n data values. In some embodiments, for at least one value of i, wherein 1<i<n, the i^{th} prose string includes the i^{th} data field value.

In some embodiments, for at least one i, wherein 1<i<n, the i^{th} prose string includes a value derived from a calculation including the i^{th} data field value and one or more further data field values.

In some embodiments, the string of plain language prose provides an historical overview of a company attribute for a company in respect of which the share is issued.

In some embodiments, the string of plain language prose provides a result and an explanation of steps taken to achieve, or primary factors that have influenced or would influence, that result.

In some embodiments, the string of plain language prose explains performance against a predefined measure, reference or benchmark value.

In some embodiments, the string of plain language prose explains an historical average or trend and presents a corresponding recent performance result.

In some embodiments, the string of plain language prose explains a relationship between debt, equity and financial performance. In some embodiments, the string of plain language prose explains a cash funding gap. In a preferred aspect of these embodiments, the string of plain language prose explains how a cash funding gap might be rectified or mitigated.

In some embodiments, the string of plain language is presented in a page that additionally presents a chart and/or numerical data corresponding to the values for the identified data fields.

In some embodiments, the plain language conversion algorithm incorporates a conjunction selection algorithm adapted to identify conjunctive words or phrases for verbally linking prose strings or prose sub-strings together thereby to provide enhanced meaning or enhanced natural expression.

In a second aspect, the invention provides a computer program product for performing a method as described.

In a further aspect, the invention provides a non-transitive carrier medium for carrying computer executable code that, when executed on a processor, causes the processor to perform a method as described.

In yet another aspect, the invention provides a computer system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may do so. Furthermore, the particular features, structures or characteristics may be combined in any suitable manner, permutation and combination even if not explicitly disclosed, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms “comprising”, “comprised of or “which comprises” is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms “including” or “which includes” or “that includes” as used herein is also an open term that means including at least the elements/features that follow the term, but not excluding others. Thus, including is synonymous with, and means the same as, comprising.

### BRIEF DESCRIPTION OF THE DRAWINGS

Embodiments of the invention will now be described, by way of example only, with reference to the accompanying drawings, in which:

FIG. 1 schematically illustrates a system according to one embodiment of the invention;

FIG. 2A illustrates a method according to one embodiment;

FIG. 2B illustrates a method according to one embodiment;

FIG. 2C illustrates a method according to one embodiment;

FIG. 3 illustrates we web-delivery framework according to one embodiment;

FIG. 4 illustrates a screenshot generated according to one embodiment.

### DETAILED DESCRIPTION

Described herein are systems and methods for providing share assessment data.

For example, one embodiment takes the form of a computer implemented method performed by a web server for delivering data to client terminals, thereby to enable the rendering of share assessment data in chart form. The web server provides a client interface (which is renderable in a client web browser), this interface being configured to display a plurality of charts. In overview, the charts include graphical markers respectively indicative of a plurality of shares, each marker having a visual feature indicative of a relationship between a share price rating and share quality rating for its respective share. For a given share, the graphical marker preferably retains the same visual feature(s) or at least one common indicative characteristic across the plurality of charts.

Other embodiments include related methodologies performed by client terminals, both in the context of executing web-delivered code from a web server, and in the context of executing local proprietary applications. Some embodiments include hardware components and/or carrier media associated with the implementation of such methodologies.

EXEMPLARY SYSTEM

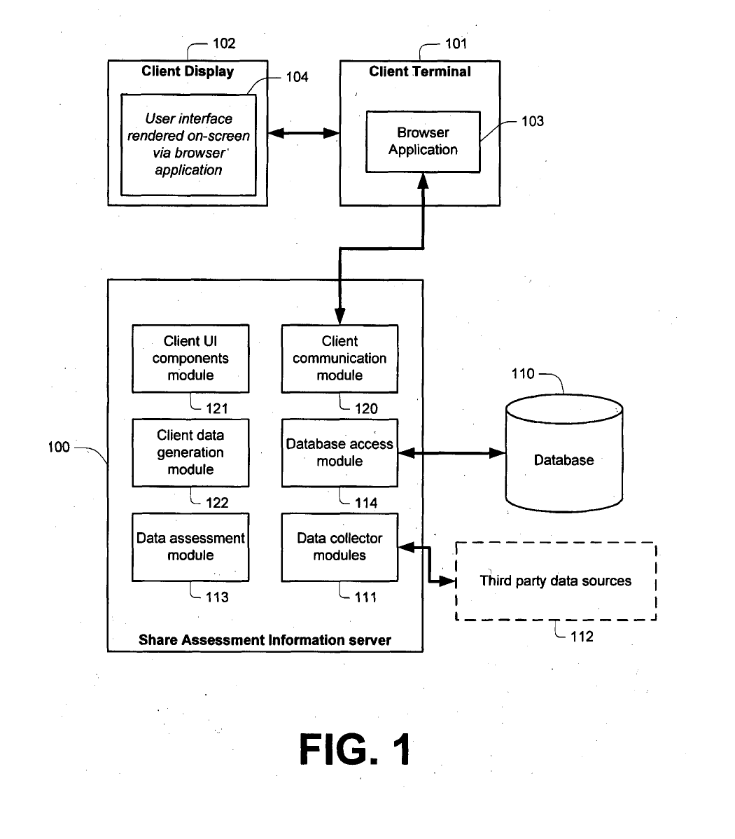

FIG. 1 illustrates an exemplary system whereby a share assessment information server 100 delivers computer executable code to a plurality of client terminals via the Internet. An exemplary client terminal 101 is illustrated in combination with an associated client display 102. A browser application 103 (such as Microsoft Internet Explorer or Google Chrome) executes on client terminal 101. Code delivered by server 100 is rendered via browser application 103 thereby to provide an on-screen rendering 104 of a client interface provided by server 100.

It should be appreciated that the example of a browser/server arrangement is exemplary only. In some embodiments, a proprietary application executes on terminal 101, that proprietary application including computer executable code for allowing terminal 101 to perform various functionalities of server 100 discussed below. For example, such an approach is in some cases preferable for mobile device applications, such as applications coded for iPhone or Android platforms.

In overview, server 100 is configured for performing various computer-implemented methods for providing share assessment data. In some cases, such a method includes maintaining access to a repository of data for a plurality of shares. In the context of FIG. 1, that data is maintained in database 110. As used herein, the expression “maintaining access” requires only that server 100 is able to access data in database 110 as needed. That is, the access need not be continuous; but may be periodic or spasmodic. In some cases database 110 is physically housed at a location remote of server 100 (optionally jurisdictionally remote). Additionally, it will be appreciated that server 100 and/or database 110 may be defined by a plurality of distributed components.

The term “share assessment data”, and other references to information concerning shares, should be read broadly to include data and/or information concerning the entity in respect of which the share is issued. For example, share assessment data may include a wide range of company financial information, such as revenue, expense, profit and cash flow information, as well as other quantitative or qualitative data.

In the embodiment of FIG. 1, server 100 includes data collector modules 111 that are configured to obtain information from third party data sources 112. For example, modules 111 are configured to extract data from RSS feeds or the like, such that database 110 is able to be updated with new information. In the illustrated embodiment a data assessment module 113 receives data from collector modules 111 and processes that data into a form appropriate for input to database 110. A database access module 114 is configured to input the new data into database 110. Database access module 114 is additionally configured for performing other database operations, such as handling database queries and the like.

As foreshadowed above, server 100 is configured to provide a client interface for clients, such as client 101. In this regard, server 100 includes a client communication module 120, which is responsible for handling the delivery of data to clients, and the receipt of data from clients. For example, module 120 is configured for receiving data indicative of the interaction of a user of client terminal 101 with the client interface (as rendered on display 103). The received data is processed, for example to allow handling of requests for new pages, elements, objects, refreshed renderings, and so on. A client UI components module 121 is configured for defining UI components that are to be delivered to client terminal 101 via module 120. A client data generation module 122 is configured to generate specific data for display at client terminal 102, such as charts, diagrams, and the like. That is, at a general level, module 121 defines objects configured to contain data, and module 122 generates the data to be contained in those objects.

GENERATION OF CHARTS

Among a range of other functionalities, the client interface provided by server 100 and rendered at client terminal 101 is configured to display a plurality of charts (although not necessarily simultaneously; in some embodiments the charts may be displayed one at a time). The embodiments discussed herein are particularly focused on the generation and presentation of such charts.

In overview, for the charts considered herein, each chart provides information regarding a selection of the shares for which data is maintained in database 100. In some cases the selection is defined by all of the available shares for which data is stored. However, more preferably, one or more rules/filters are applied thereby to transform the full gamut of shares to a reduced selection. For example, one filter excludes all shares having zero intrinsic value, according to a predefined intrinsic valuation algorithm.

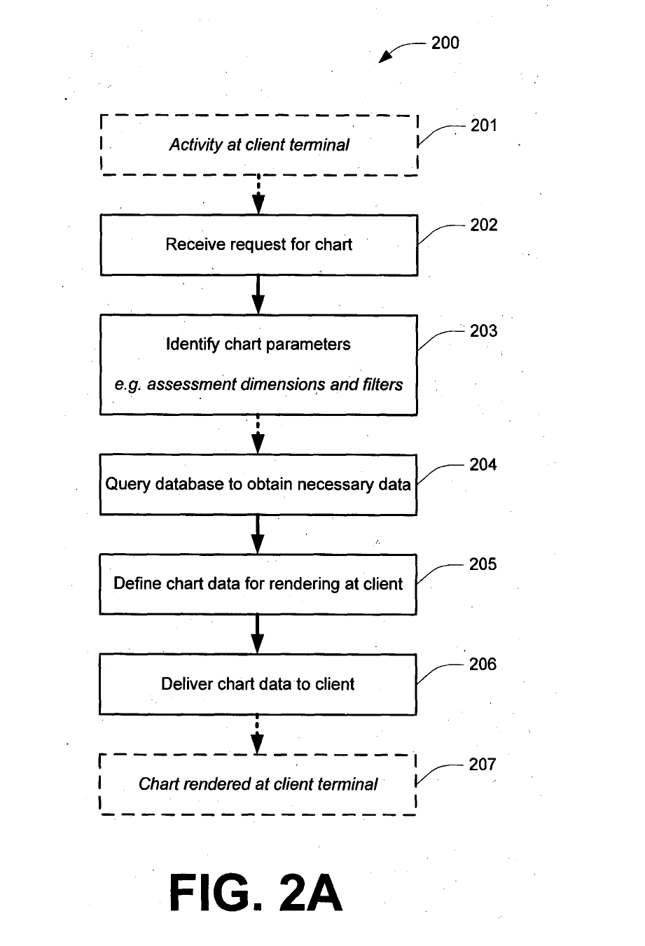

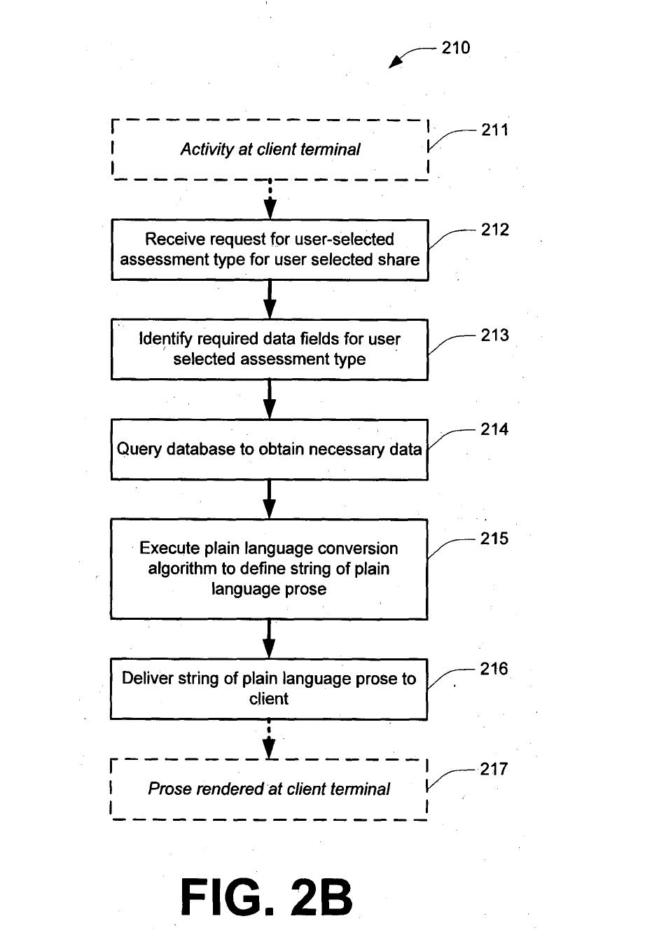

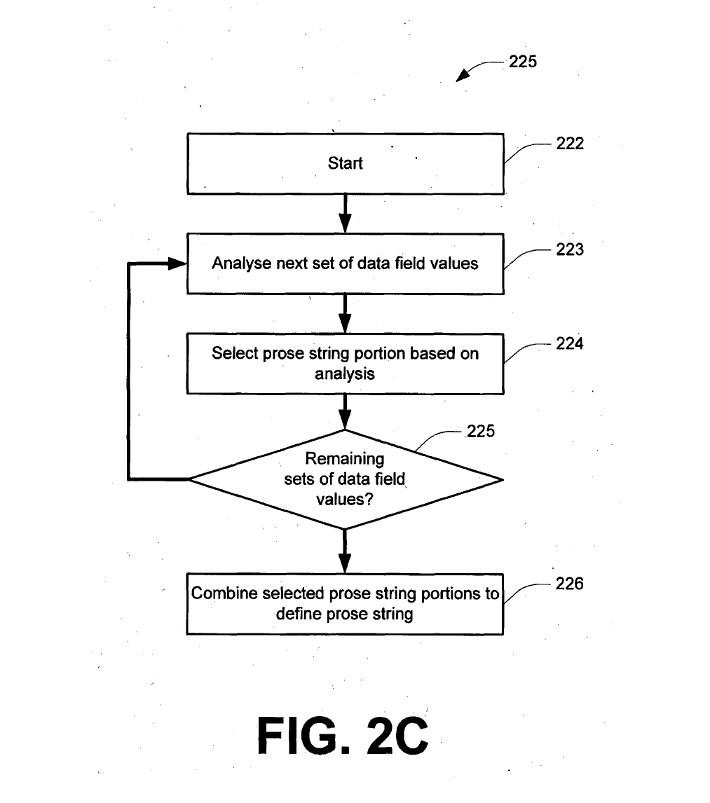

FIG. 2A illustrates a computer implemented method according to one embodiment, this method being performed in substance by server 100, thereby to allow a chart to be displayed at client terminal 101. In FIG. 2A, functional blocks bordered by dashed lines represent processes performed by components other than server 100.

Functional block 201 represents a process whereby activity occurs at client terminal 101, specifically in terms of interaction between a user and the client interface which results in a request to display a chart. For example, this might include the user navigating to a page that is configured to display a particular chart. This results in a request for a chart being received by server 100 at 202. Server 100 then identifies chart parameters at 203. The term “chart parameters” describes factors such as assessment dimensions (for example an x-axis assessment dimension and y-axis assessment dimension in the context of a line chart or scatter chart) and filters (for example whether the chart is to display data for a single share, a defined group of shares meeting specific requirements, and so on). In some cases predefined sets of chart parameters are stored to simplify this process (for example the request may be to provide “chart type #1234”). Based on the chart parameters, server 100 conducts a query of database 110 (via module 114) at 204 thereby to obtain the data necessary to generate that chart. Module 122 is then operated at 205 to define data for rendering of the relevant chart at terminal 101, with this data being provided to terminal 101 at 206. Terminal 206 then renders the relevant chart at 207.

It will be appreciated that FIG. 2A is an exemplary method only, and that in other embodiments modified methods are used. For example, optimizations are optionally incorporated into the methodology thereby to reduce latency between client requests and chart data provision, and/or to allow an already-rendered chart to be updated with new data and/or parameters (such as filters).

In some cases, for each of the selections of the shares that are to be displayed in a chart, respective graphical markers are used to illustrate the attributes of each share in the selection relative to a set of assessment dimensions. For example, the chart may be a scatter chart, and a graphical marker (such as a dot, cross, or the like) is used to identify the position of each share on the chart relative to the assessment dimensions (which are displayed on the x-axis and y-axis).

Preferably, each graphical marker includes a link to a page or object provided by the client interface that displays additional information regarding the share to which that graphical marker relates. That is, by clicking on a graphical marker, a user is provided with additional “drill-down” information concerning the relevant share (optionally including access to further share-specific charts). In some cases the client interface is configured such that hovering a cursor over a given marker provides “pop-up” information (such as company name, key financial statistics and the like).

TRANSFORMATION OF SHARE ASSESSMENT DATA INTO PLAIN LANGUAGE

In some embodiments, server 100 is configured for transforming share assessment data into plain language. For example, in some cases module 122 is configured to execute a plain language conversion algorithm thereby to generate a string of plain language prose based on information in database 110. This string of plain language prose is defined in a manner intended to convey or explain the meaning and/or relevance of various data field values in database 110 in the context of a particular form of assessment, such as comparative analysis for the purpose of value investing.

As used herein, the notion of “plain language” refers to the use of words, phrases and/or sentences in combination with numerical values, to provide those numerical values with verbal context and meaning. The words, phrases or sentences are grouped into a string (optionally being separated into paragraphs or bullet-style points) thereby to provide a string of meaningful and natural prose that is readable by a user.

FIG. 2A illustrates a computer implemented method according to one embodiment, this method being performed in substance by server 100, thereby to allow transformation of share assessment data into a string of plain language prose, which is subsequently displayed at client terminal 101. In FIG. 2A, functional blocks bordered by dashed lines represent processes performed by components other than server 100.

Functional block 211 represents a process whereby activity occurs at client terminal 101, specifically in terms of interaction between a user and the client interface which results in a request to display a string of plain language prose. For example, this might include the user selecting a particular share, and navigating to a page that is configured to display a particular set of assessment data, such as share price, cash flow assessment, capital history assessment, share value assessment, share quality assessment, or the like. The user activity may also include an activity that does not explicitly select a share or request an assessment; as those selections might be implied and automated on the basis of other activities or selections. In any case, the user activity results in a share assessment request being received at server 100 at 212. The share assessment request is indicative of a user-selected share and a user-selected assessment type, depending on the user activity at and preceding 211.

Server 100 identifies data fields required for the user-selected assessment type at 213. For example, server 100 is configured to store data indicative of a set of data fields associated with each assessment type. This is in some cases stored in the form of a predefined database query or query structure. Server 100 then obtains, from database 110, for the user-selected share, values for the identified data fields at 214. This data (or a subset thereof) is used as input for a plain language conversion algorithm defined for the user-selected assessment type at 215. A plain language conversion algorithm is defined for each assessment type, and additional detail regarding execution of such an algorithm is provided below. However, in general terms, sets of data field values (being sets of one or more) are analyzed in an order defined for the algorithm, thereby to define corresponding prose string portions. These prose string portions are then linked together by the algorithm, to form a string of plain language prose for delivery to the client. This is delivered to the client at 216, and subsequently displayed to the client at 217.

It will be appreciated that FIG. 2B is an exemplary method only, and that in other embodiments modified methods are used. For example, optimizations are optionally incorporated into the methodology to reduce latency between client requests and data provision. In some cases, the method is varied such that database queries are performed over the course of step 215 as opposed to all data being pre-obtained at step 214.

FIG. 2C illustrates an example of the algorithm of step 215 according to one embodiment. The method commences at 222. On a first iteration of the method, the process at 223 includes analysing a first set of data field values. Where the first set of data field values is defined by a single data field value, process 223 includes determining that value. That value is then compared with a table that associates data field values with a group of potential first string portions defined for the algorithm. For example, values in one range are associated with one potential first string portion, and values in another range are associated with another potential first string portion. Where the set of data field values is defined by multiple data field values, step 223 includes processing those values based on a predefined formula (which may include basic operations such as multiplication, division, addition or subtraction, as well as more complex operations such as averaging, interpolation, extrapolation, comparative analysis, statistical analysis and so on) thereby to determine a resultant calculation value. That resultant calculation value is then compared with a table that associates data field values with a group of potential first string portions defined for the algorithm. For example, resultant calculation values in one range are associated with one potential first string portion, and resultant calculation values in another range are associated with another potential first string portion. Based on the analysis at 223, a first prose string portion is selected at 224.

As indicated by decision 225, steps 223 and 224 are repeated for a second data field value to an n^{th} (where n>2) data field value thereby to select a second prose string portion through to a n^{th} prose string portion. After completing step 224 for the n^{th} prose string portion, the method progresses through decision 225 to step 226. Step 226 includes combining the first to n^{th} prose string portions thereby to define the string of plain language prose for provision to the client.

Again, it will be appreciated that FIG. 2C is an exemplary method only, and that in other embodiments modified methods are used. For example, in some embodiments additional steps are performed to increase the language standard of the string of plain language prose, for example by applying a conjunction selection algorithm thereby to identify conjunctive words (such as “and”, “but”, “because”, “however”, etc) for linking the prose string portions together verbally, in more meaningful or more natural ways.

In some embodiments, for an i^{th} iteration of the algorithm, wherein 1<i<n, the i^{th} prose string is selected based on analysis of the i^{t}h data field value and a further one (or more) of the data field values. For example, this is relevant where an i^{th} set of data values includes multiple values, and/or where there are greater than n data values.

In some cases, for at least one i, wherein 1<i<n, the i^{th} prose string is selected based on analysis of the i^{th} set of data field values and a k^{th} prose string, wherein 1<k<i. That is, the algorithm may operate such that a preceding selected prose string effects a subsequent prose string selection. For example, an “IF” operator may be used to differentiate between alternate sets of value range to prose string portion associations (e.g. IF prose string X has been selected, associate value range Y with prose string Z, IF prose string X′ has been selected, associate value range Y′ with prose string Z′). In some cases, for at least one i, wherein 1<i<n, the i^{th} prose string includes a data field value for one or more data values in the i^{th} set of data field value, or a value derived from one or more of those data field values.

The manner by which plain language prose is used varies between embodiments. Some examples of prose strings and prose string portions are provided below. In these examples, square brackets are used to indicate variables
Providing a historical overview of an attribute for the company in respect of which shares are issued (e.g. between [value] and [value] the company profits have [increased/ declined] from [value] to [value]).
Providing a result and an explanation of steps taken to achieve that result, or factors contributing to that result (e.g. a [value] decline in return on equity has resulted from an increase in shareholder equity of [value], and a decline in retained profits of [value].
Explaining performance against a predefined measure or KPI (e.g. a cash flow ratio of greater than 0.80 is preferable, and the company in this case has a cash flow ratio of [value]).
Providing an historical average and a corresponding recent performance result (e.g. between [value] and [value] the company [increased/reduced] profits from [value] to [value], but in the past year profits have [increased/reduced] from [value] to [value].

Two slightly more complex examples are provided below, these examples being set out in terms of a simplified algorithm for generating a prose string. The first example relates to explanation of a relationship between debt, equity and performance, and the second explains a funding gap (or surplus).

Example 1:

The following steps provide an exemplary partial algorithm for providing an assessment of a relationship between debt, equity and profit performance. It will be appreciated that this is provided for illustrative purposes only.

(i) Determine start profit value, end profit value, change in profit value, and per annum profit change percentage for defined assessment period.

(ii) IF change in profit value positive AND start profit value positive AND end profit value positive, use string portion profits have increased for [value1], IF change in profit value negative AND start profit value positive AND end profit value positive, use string portion profits have decreased for [valuel], IF change in profit value positive AND start profit value negative AND end profit value negative, use string portion losses have decreased [valuel], IF change in profit value negative AND start profit value negative AND end profit value negative, use string portion losses have increased for [valuel], IF change in profit value positive AND start profit value negative AND end profit value positive, use string portion profits have increased, from what was a loss, for [valuel], IF change in profit value negative AND start profit value positive AND end profit value negative, use string portion losses have increased, from what was a profit, for [valuel].

(iii) IF change in profit value positive AND start profit value positive AND end profit value positive, use string portion increase in profit for [value2], IF change in profit value negative AND start profit value positive AND end profit value positive, use string portion decrease in profit for [value2], IF change in profit value positive AND start profit value negative AND end profit value negative, use string portion decrease in losses [value2], IF change in profit value negative AND start profit value negative AND end profit value negative, use string portion increase in losses for [value2], IF change in profit value positive AND start profit value negative AND end profit value positive, use string portion increase to profit, for [value2], IF change in profit value negative AND start profit value positive AND end profit value negative, use string portion decrease to a position of loss, for [value2].

(iv) For String Portion 1, use string portion Since [start of assessment period], [company name] ‘s [value]] by [profit change percentage] per annum from [start profit value] to [end profit value].

(v) Determine shareholder input equity value for assessment period.

(vi) IF shareholder input equity value positive, use string portion To generate this [change in profit value] [value2], shareholders have put in equity of [shareholder input equity value]. (vii) Determine retained earnings value for assessment period.

(viii) IF retained earnings value positive, use string portion Furthermore, shareholders have left in earnings of [retained earnings value] for String Portion 3; and (ix) IF retained earnings value negative, use string portion Furthermore, retained earnings have decreased by [retained earnings value] for String Portion 3.

(x) Determine average return on equity value for assessment period and return on equity at end of period.

(xi) For String Portion 4, use Return on Equity is the best measure of economic performance, and [company name] has averaged [average return on equity value] since [start of assessment period]; recently generating a Return on Equity of [return on equity at end of period].

Using this algorithm, and a set of example values, the following string may be generated:

Since 2001, XYZ Corporation's profits have increased by 19.44% per annum from $6.604M to $32.664M.

To generate this $26.060M increase in profit, shareholders have put in equity of $36.232M. Furthermore, shareholders have left in earnings of $48.143M.

Return on Equity is the best measure of economic performance, and XYZ Corporation has averaged 28.18% since 2001; recently generating a Return on Equity of 31.73%.

It will be appreciated that this automated approach usefully provides understandable context to the underlying data, in plain language.

Example 2:

The following steps provide an exemplary partial algorithm for providing an assessment of the cash flow performance of a business, in terms of a funding gap (or surplus). In this embodiment, a different algorithm format has been used as compared with the example above.

(i) Set Company Name value to valuel. (ii) Set Reported Net Profit After Taxes value to value2. (iii) If value2 positive, set StringModl to “Net Profit After Taxes”. (iv) If value2 negative, set StringModl to “Net Loss After Taxes”. (v) Set Cash Flow from Operations value to value3. (vi) Determine Cash Flow Ratio value (value3/value2). (vii) Set Cash Flow Ratio value to value4. (viii) Set Invested Amount value to value5. (ix) Set Dividends Paid value to value6. (x) Determine Other Payments value. (xi) Set Other Payments value to value7.

(xii) Determine Surplus/Gap value (Surplus/Gap =Cash Flow After Investing -Dividends Paid +Other Financing Cash Flow +Foreign Exchange Effects).

(xiii) IF Surplus/Gap value positive, set StringMod2 to lunding surplus of

[Surplus/Gap value], ELSE set StringMod2 to lunding gap of [Surplus/Gap value]. (xiv) IF Surplus/Gap value positive, set StringMod3 to “This surplus indicates that [value2] does not rely on external sources of capital to fund business activities”, ELSE set StringMod3 to “this gap must be funded from potentially dilutive capital raisings, additional borrowings, or available cash”.

(xv) Complete string portions:

Since [value]], [value2] has reported [StringMod]] of [value2] and generated [value3] in Cash Flow from Operations. This amounts to a Cash Flow Ratio (which measures the quality of reported earnings) of [value4]. Greater than 0.80 is preferable.

Over the same period, [value2] has invested [value5], paid dividends of [value6], and has paid out other financing cash flows and foreign exchange of [value7]. The total of these business activities when compared to Cash Flow from Operations produces a [StringMod2].

[StringMod3].

Using this algorithm, and a set of example values, the following string may be generated:

Since 2001, XYZ Corporation has reported Net Profit After Taxes of $158.349M and generated $169.047M in Cash Flow from Operations. This amounts to a Cash Flow Ratio (which measures the quality of reported earnings) of 1.07. Greater than 0.80 is preferable.

Over the same period, XYZ Corporation has invested $68.346M, paid dividends of $92.865M, and has paid out other financing cash flows and foreign exchange of $2.088M. The total of these business activities when compared to Cash Flow from Operations produces a funding surplus of $5.685M.

This surplus indicates that XYZ Corporation does not rely on external sources of capital to fund business activities

Once again, it will be appreciated that this provides a useful automated approach for providing understandable context to the underlying data. Furthermore, it will be appreciated that these examples are not to be regarded as necessarily limiting in any way.

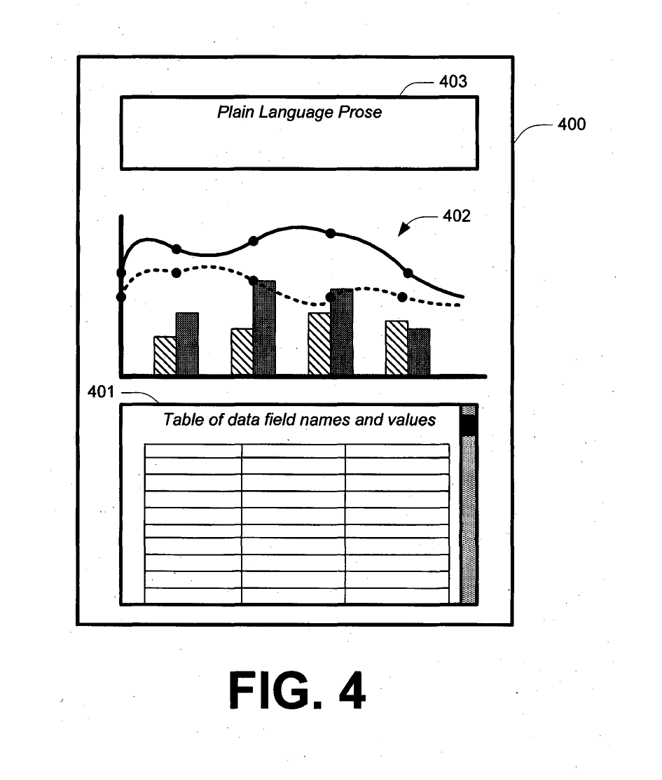

Preferably, the string of plain language prose is presented in a webpage that additionally presents a chart and/or numerical data corresponding to the values for the identified data fields. Most preferably, the plain language prose, chart and numerical value are presented side-by-side as shown in the exemplary screenshot of FIG. 4.

In FIG. 4, a webpage includes a page 400, which is rendered to provide information about a user-selected share based on a user-selected assessment type. Page object 401 includes a table that is populated with data field names and data field values extracted from database 110. The fields are selected based on the user-selected assessment type, and values correspond to the user-selected share. Some or all of these values (optionally in combination with other values) are used to generate a chart object 402 to graphically illustrate one or more aspects of the assessment. A string of plain language prose is generated from some or all of the data field values based on technologies and methodologies discussed herein, thereby to populate page object 403 with plain language prose.

The present three-way presentation approach is particularly significant as it provides both verbal and graphical context to the detailed (but often more difficult to understand or interpret) numerical data values in object 401. In this manner, a user is provided with useful context to understand the significance of these values in relation to the associated shares and underlying businesses. This in turn allows the user to better understand the influences and implications in terms of investment risk and return, thereby to make better informed investment decisions. This understanding and insight may also be valuable to those directly involved in the management or governance of such businesses.

EXEMPLARY WEB-DELIVERY FRAMEWORK

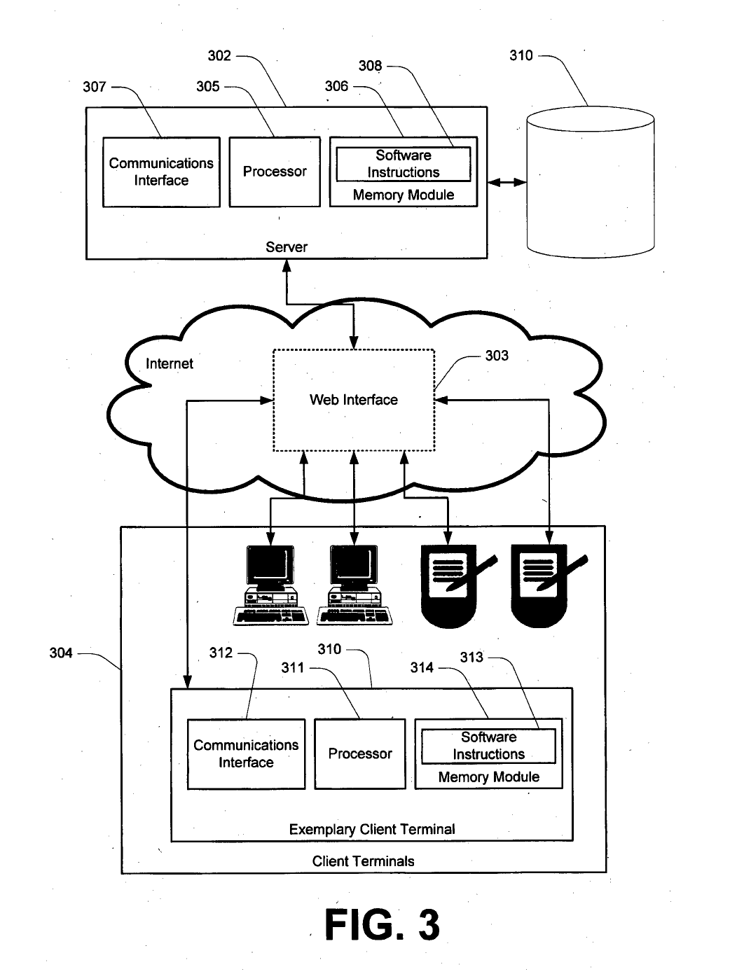

In some embodiments, methods and functionalities considered herein are implemented by way of a server, as illustrated in FIG. 3. This figure, and the following explanation, is provided as additional context to web delivery frameworks. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a client interface and allow communication with server 302. This client interface allows for the creation, viewing and administration of profiles, access to the internal communications interface, and various other functionalities.

CONCLUSIONS AND INTERPRETATION

It will be appreciated that the disclosure above provides various significant systems and methods for providing share assessment data, particularly in terms of transforming share assessment data into plain language. In this manner, a user is provided with useful context to understand how these figures change better shares, and their meanings, thereby to make better informed investment decisions.

Unless specifically stated otherwise, throughout the specification terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system.

Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein.

The invention is not limited to any particular programming language or operating system.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth.

However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention. This listing of claims will replace all prior versions, and listings, of claims in the application Listing of claims 1.-21. (Canceled)

22. A computer-implemented method for transforming share assessment data into plain language, the method comprising:
maintaining access to a repository of data for a plurality of shares;
receiving, from a client, a share assessment request, the share assessment request being indicative of a user-selected share and a user-selected assessment type;
identifying a set of data fields associated with the user-selected assessment type;
obtaining from the repository, for the user-selected share, values for the set of data fields;
executing a plain language conversion algorithm defined for the user-selected assessment type in respect of the values thereby to generate a string of plain language prose; and
providing the string of plain language prose for display to the client.

23. The computer-implemented method of claim 22, wherein executing the plain language conversion algorithm includes:
(i) analysing a first data field value;
(ii) based on the analysing the first data field value, selecting a first prose string portion from a group of potential first prose string portions;
(iii) repeating (i) and (ii) for a second data field value to an n^{th} data field value thereby to select a second prose string portion to an n^{th} prose string portion, where n>2; and
(iv) combining the first prose string portion to the n^{th} prose string portions thereby to define the string of plain language prose.

24. The computer-implemented method of claim 23, wherein for at least one value of i, wherein 1<i<n, an i^{th} prose string is selected based on analysis of an i^{th} data field value and at least a further one of the values for the set of data fields.

25. The computer-implemented method of claim 23, wherein for at least one value of i, wherein 1<i<n, an i^{th} prose string is selected based on analysis of an i^{th} data field value and a k^{ill} prose string, wherein 1<k<i.

26. The computer-implemented method of claim 23, wherein there are greater than n data values.

27. The computer-implemented method of claim 23, wherein for at least one value of i, wherein 1<i<n, an i^{th} prose string includes an i^{th} data field value.

28. The computer-implemented method of claim 23, wherein for at least one i, wherein 1<i<n, an i^{th} prose string includes a value derived from a calculation including an i^{th} data field value and one or more further values for the set of data fields.

29. The computer-implemented method of claim 22, wherein the string of plain language prose provides a historical overview of a company attribute for a company in respect of which the share is issued.

30. The computer-implemented method of claim 22, wherein the string of plain language prose provides a result and an explanation of one of steps taken to achieve and primary factors that have influenced that result.

31. The computer-implemented method of claim 22, wherein the string of plain language prose explains performance against a predefined measure.

32. The computer-implemented method of claim 22, wherein the string of plain language prose explains one of a historical average or a historical trend, and presents a corresponding performance result.

33. The computer-implemented method of claim 22, wherein the string of plain language prose explains a relationship between debt, equity and financial performance.

34. The computer-implemented method of claim 22, wherein the string of plain language prose explains a cash funding gap.

35. The computer-implemented method of claim 22, wherein the string of plain language prose explains how a cash funding gap might be rectified.

36. The computer-implemented method of claim 22, wherein the string of plain language is presented in a page that presents one or more of a chart and a numerical data corresponding to the values for the set of data fields.

37. The computer-implemented method of claim 22, wherein the plain language conversion algorithm incorporates a conjunction selection algorithm adapted to identify one of conjunctive words and conjunctive phrases for verbally linking one of prose strings and prose sub-strings together thereby to provide one of enhanced meaning and enhanced natural expression.

38. The computer-implemented method of claim 22, further comprising:
providing, at the client, a web-browser application; and
operating the web-browser application thereby to display the string of plain language prose.

39. A non-transitive carrier medium comprising computer executable code that, when executed on a processor, causes the processor to:
maintain access to a repository of data for a plurality of shares;
receive, from a client, a share assessment request, the share assessment request being indicative of a user-selected share and a user-selected assessment type;
identify a set of data fields associated with the user-selected assessment type;
obtain from the repository, for the user-selected share, values for the set of data fields;
execute a plain language conversion algorithm defined for the user-selected assessment type in respect of the values thereby to generate a string of plain language prose; and
provide the string of plain language prose for display to the client.

40. The non-transitive carrier medium of claim 39, wherein the computer executable code that, when executed on the processor, causes the processor to execute the plain language conversion algorithm further causes the processor to:
(i) analyse a first data field value;
(ii) based on the analysing the first data field value, select a first prose string portion from a group of potential first prose string portions;
(iii) repeat (i) and (ii) for a second data field value to an n^{th} data field value thereby to select a second prose string portion to an n^{th} prose string portion, where n>2; and
(iv) combine the first prose string portion to the n^{th} prose string portions thereby to define the string of plain language prose.

41. The non-transitive carrier medium of claim 40, wherein for at least one value of i, wherein 1<i<n, an i^{th} prose string is selected based on analysis of an i^{th} data field value and at least a further one of the values for the set of data fields.
